(19) United States
(12) Patent Application Publication
(10) Pub. No.: US 2011/0299425 A1
(43) Pub. Date: Dec. 8, 2011

(54) Addressing and Routing Scheme for Distributed Systems

(76) Inventor: Praveen Kumar, Bangalore (IN)

(21) Appl. No.: 13/201,326

(22) PCT Filed: Feb. 11, 2010
(86) PCT No.: PCT/IN10/00078

§ 371 Date: Aug. 12, 2011

(30) Foreign Application Priority Data
Feb. 12, 2009 (IN) 307/CHE/2009

(51) Int. Cl. H04W 72/04; H04L 12/28

(52) U.S. Cl. 370/255

(57) ABSTRACT

The embodiments herein relate to distributed systems and more particularly, to logical address allocation and data routing in a distributed systems. A plurality of methods for logical address allocation are disclosed, which the network adapts based on the configurable parameters and the network working environment. Since the nodes are allocated logical address based on the algorithm, while routing the data packet each node calculates the shortest path next hop towards the destination based on the algorithm used for addressing and forward the data.

### FIELD OF THE INVENTION

The embodiments herein generally relate to distributed systems, and, more particularly, to logical address allocation and data routing in a distributed systems.

### CROSS REFERENCE TO RELATED APPLICATIONS

This specification is the complete specification of the provisional application No. 307/CHE/2009 filed on 12 Feb. 2009 which it claims to be its priority date.

### BACKGROUND OF THE INVENTION

In any distributed system, the nodes are assigned a logical address apart from their hardware address at the time of association in the network. These logical addresses are then normally used for all the communications with that node. As an example IP address is a logical address over the hardware Ethernet address or mobile subscriber number is a logical address over its IMEI (International Mobile Equipment Identity); and during the communication mostly these logical addresses are used to identify the nodes. Normally, the logical addresses are short in length so that it is easy to remember and handy to use. Short length of logical address necessitates that the addresses are allocated prudently. This invention proposes an efficient way of allocating logical address. Also if address allocation is based on some algorithm, routing the data from one node to other node can be done efficiently. Hence this invention also includes an efficient method for data routing in a distributed system.

In accordance with existing address allocation methods, the logical address allocation methods have limited configurable parameters, which block the significant amount of logical address unused, in anticipation of getting used in future, but in many cases the scenario never arises and the blocked addresses never get used. In this invention we are allocating the address prudently by calculating in advance the maximum possible requirement at any node in the network and reserve the address accordingly. Being adaptive in nature, this invention also allows user to choose different level of robustness in network formation i.e. the different level of probability of any unassociated node getting associated with the network. As we can understand, to improve the chance of any device within the region is getting associated with the network; the network will have to block extra address, means network robustness is inversely proportional to the maximum possible depth of the network.

In accordance with IEEE 802.15.4 standard, an exemplary standard of a wireless communication network, viz., wireless sensor network (WSN), the logical address can be of maximum 16 bits length. WSN is a type of ad-hoc wireless communication system which consists of small sensor nodes with sensing, computational and wireless communication capabilities. The main characteristics of such a network are that it is self-organizing, self-healing and the nodes are battery powered. For many applications such as intruder detection at border, underwater environment or contaminant monitoring, land slide monitoring, large industry automation etc, these nodes are distributed randomly over a large region; the node senses the desired phenomena and sends the information to the controller. For many cases the deployment of such a sensor network will be feasible only if it can run for several years without any human intervention. In large networks where nodes are battery-powered, energy should be used most prudently and efficiently. Efficiency of routing algorithm has major stake in overall efficiency of any network. This invention proposes algorithms for assigning logical address to the network elements, based on the addressing scheme and correspondingly data routing algorithm is also developed to calculate the shortest path between any two nodes.

Typically, a WSN could include a personal area network controller (PC), router nodes (RN), and end device (ED). PC is a full function device which is a principle coordinator of the network, also referred as sync node. RN is also a full function device, which is associated with one of the full function device, i.e. either PC or another RN, and has associated some full function device and/or reduced function device as its child. ED is a network element which is associated with either PC or RN and it has not associated any device as its child. The node with which the other nodes are associated is called as parent node of the associated nodes and the associated nodes are called child nodes of the parent node. ED can be either full function device or reduced function device, based on the address allocation algorithm and the device capability. In small range network, star topology is sufficient and a single coordinator PC manages the whole network, but the large network forms by plurality of layers of router nodes (RNs) associated with each others, in the form of tree. Typically, the EDs, RNs and PC are battery powered.

IEEE 802.15.4 standardizes only physical (PHY) and medium access control (MAC) layers which are not responsible for either address allocation or data packet routing, but as per IEEE 802.15.4 the nodes are assigned a 16-bit short address at the time of association. Therefore at the time of association, router node (PC is considered as principle router node) either calculates the address by itself based on algorithm or finds out from the personal area network controller (PC). Finding out address from the PC can be a costly affair in large network. All the activities involved in this process, like contending for channel using carrier sense multiple access with collision avoidance (CSMA-CA), transmission and reception are very power consuming tasks and if this happens at plurality of hops and for plurality of times it is very power inefficient solution.

Existing algorithms provide pre-configurable values for maximum number of child router and end device a coordinator can have as its child. These values are defined at the beginning itself, so that each node blocks the logical address accordingly. This algorithm has limitation that it cannot grow very large, because even if a node can have only 2 child routers, the numbers of routers grow two times at every depth and with the limitation of 16-bit logical address, the network cannot have more than 15 depths. This is a big constraint for many applications such as border area surveillance or large industry automation. The present invention proposes algorithms to calculate the logical address by the parent nodes to assign its child's logical address. It allocates the address prudently so that the network grows longer than existing algorithms and also covers the desired area fully without leaving holes. Calculating the address by the parent node itself removes the need of sending the request to PC for logical address allocation, which improves the power efficiency of address allocation procedure. Also since the address allocation is based on algorithm, the shortest path is calculated at the time of data routing.

### BRIEF DESCRIPTION OF THE DRAWINGS

The present invention is illustrated by way of example, and not by way of limitation. In the figures of the accompanying drawings and in which like reference numerals refer to similar elements and in which:

FIG. 1 illustrates an exemplary wireless sensor network (WSN).

FIG. 2 illustrates an exemplary coverage area by (n−1)^{th} depth router node at (n)^{th} depth.

FIG. 3 illustrates the number of router nodes required at any level for different margin value, to cover the area fully.

FIG. 4 illustrates an exemplary network structure in the form of sectors and terms.

FIG. 5 illustrates an exemplary addressing scheme.

FIG. 6 illustrates an exemplary random distribution of devices which has to form a network.

FIG. 7 illustrates an exemplary network formed using the new proposed algorithm.

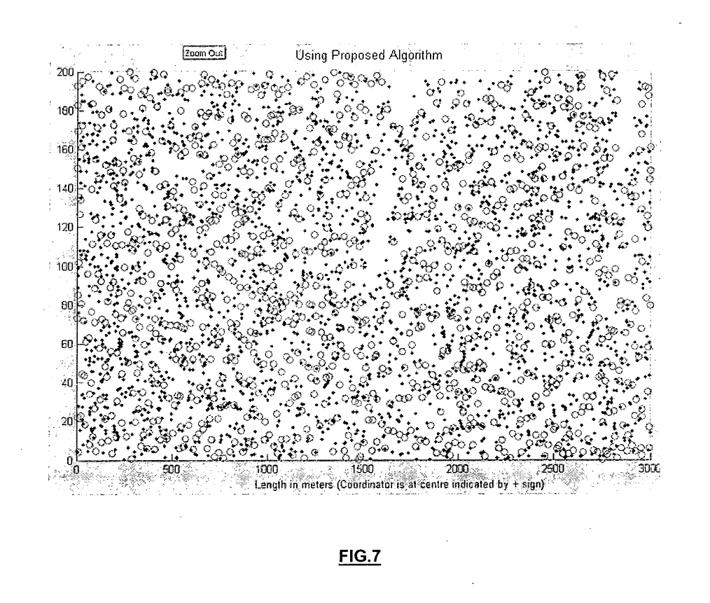

### DESCRIPTION OF THE EMBODIMENTS

Various embodiments of the present invention provide a method and system for allocating logical address to the nodes associating any network and routing data between the nodes in any distributed system. As an example the present invention has been illustrated in the context of a wireless sensor network (WSN). However, it will be apparent to those ordinarily skilled in the art the applicability of the invention to many other distributed systems.

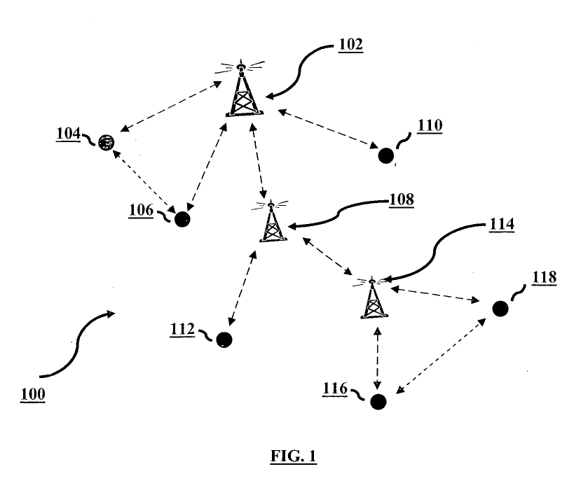

FIG. 1 illustrates an exemplary wireless network 100. 102 is illustrated as wireless personal area network controller (PC); 104, 106, 108 and 110 are associated with PC where 104, 106 and 110 are reduced function device end device (ED) and 108 is a full function device router node (RN). As illustrated, RN 108 allows further level of association with it. 112 and 114 are associated with RN 108, where 112 is an ED and 114 is a RN. RN 114 further allowing network to grow by associating 116 and 118. In this manner network can grow plurality of hops and covers the required area. The bi-directional arrows denote that the nodes are in their radio sphere of influence and can communicate with it.

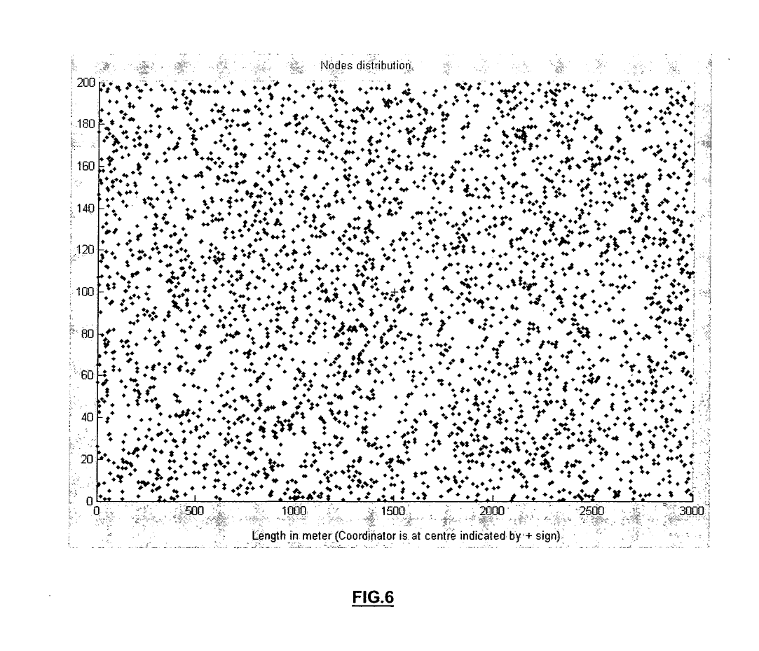

Before deriving the algorithm for address calculation, we need to understand the working environment of the devices. Typically nodes are randomly distributed across the region as illustrated in FIG. 6. Full function devices are normally redundant in number so that if one router node goes down then the nearby other full function device takes its responsibilities. In accordance with the proposed algorithm, at the time of association the parent router node prefers its child router node to be at preferable distance. Normally the parent router node prefers to have its child router node at the last part of its communication range however within its range, so that the data can be transferred with minimum retransmission and also with minimum hop. Having discussed this, we shall now define some terms which are used at the time of algorithm development. A term ‘margin’ is defined to calculate range in which router node searches for unassociated full function device in its each attempts, which is ‘m’ percent of preferable range, where m can have any positive numerical value less than equal to hundred. The preferable range is a configurable value based on transmission power and receiver sensitivity at which the parent router node prefers its child router node to be present is termed as ‘r’; since the nodes are randomly distributed the parent router node may not find any full function device to be present exactly at its preferable range. As per proposed algorithm parent router node in its first attempt to find out full function device to make next layer router node, searches at r for margin times range i.e. for m*r range. In case of failure router node searches at m*r distance closer for same m*r range, i.e. at any attempt ‘A’ router node is searching at r−(A−1)*m*r for m*r range. As discussed earlier, to form a large network the nodes are in layered form as illustrated in FIG. 1. The number of hops from the PC is termed as ‘depth’ or ‘d’.

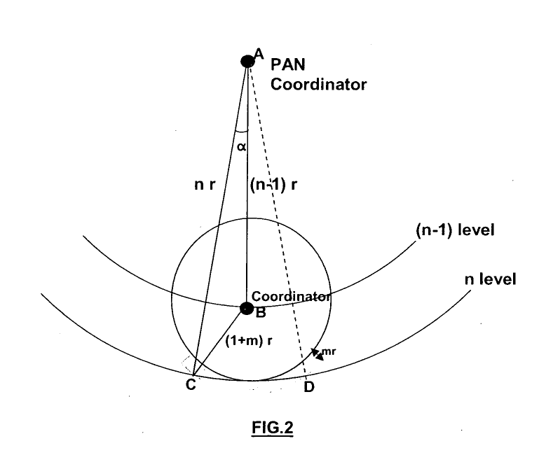

FIG. 2 illustrates the area of influence of (n−1)^{th} router node at depth n. A is the point where PC is located; B is the point where a (n−1)^{th} depth RN is located. CD is the arc at depth n which can be covered by the RN at B. Using previously defined terms and taking average values, the length of AB=(n−1)r; AC=nr; and BC=(1+m)r.

Using Solution of triangle Cosine formula on ?ABC:

$$\begin{matrix}{BC}^{2} = A {C}^{2} + {AB}^{2} - 2 \cdot A C \cdot AB \cdot Cos α ⇒ {( 1 + m )}^{2} * {r}^{2} \\ = {( nr )}^{2} + {( ( n - 1 ) r )}^{2} - 2 \cdot nr \cdot ( n - 1 ) r \cdot Cos α ⇒ α \\ = {Cos}^{- 1} [ 1 - \frac{m ( 2 + m )}{2 n ( n - 1 )} ]\end{matrix} \qquad eq 1$$

The arc CD covered by (n−1)^{th} level router at n^{th} level:

$$Since θ = ( Arc length ) / r \\ Arc CD = l \\ ⇒ 2 α = l / ( nr ) \\ ⇒ l = 2 nr {Cos}^{- 1} [ 1 - \frac{m ( 2 + m )}{2 n ( n - 1 )} ] \qquad eq 2$$

Hence number of RNs required at (n−1)^{th} level to cover n^{th} level fully is:

$${R}_{n - 1} = \frac{2 π nr}{2 {nr Cos}^{- 1} [ 1 - \frac{m ( 2 + m )}{2 n ( n - 1 )} ]} \\ ⇒ {R}_{n - 1} = \frac{π}{{Cos}^{- 1} [ 1 - \frac{m ( 2 + m )}{2 n ( n - 1 )} ]}$$

Hence at nth level number of RNs required to cover the next layer fully is:

$${R}_{n} = \frac{π}{{Cos}^{- 1} [ 1 - \frac{m ( 2 + m )}{2 n ( n + 1 )} ]} \qquad eq 3$$

The equation 3 is for omni-directional network; for directional network the equation 3 becomes:

$${R}_{n} = ⌈ ( \frac{nwkDirectionality}{directionalityFactor} ) * \frac{π}{{Cos}^{- 1} [ 1 - \frac{m ( 2 + m )}{2 n ( n + 1 )} ]} ⌉ \qquad eq 3 A$$

where,
nwkDirectionality: is a configurable parameter to indicate the directionality of network growth, such as for uni-directional network (=1), bi-directional network (=2) and so on, for omni-directional network said network directionality is equal to directionality factor of the network;
directionalityFactor: is a configurable parameter which allows user to divide the omni-directional network into that many number of factors;

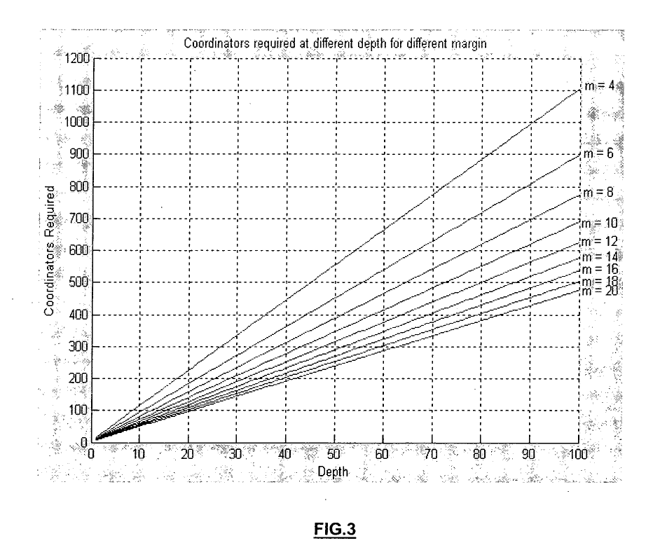

Based on the equation 3A, FIG. 3 illustrates the number of RNs required at different depth for different margin levels.

As an example for margin m=10% of range i.e. m=0.1; number of RNs required at nth level:

Rₙ≈7n eq 4

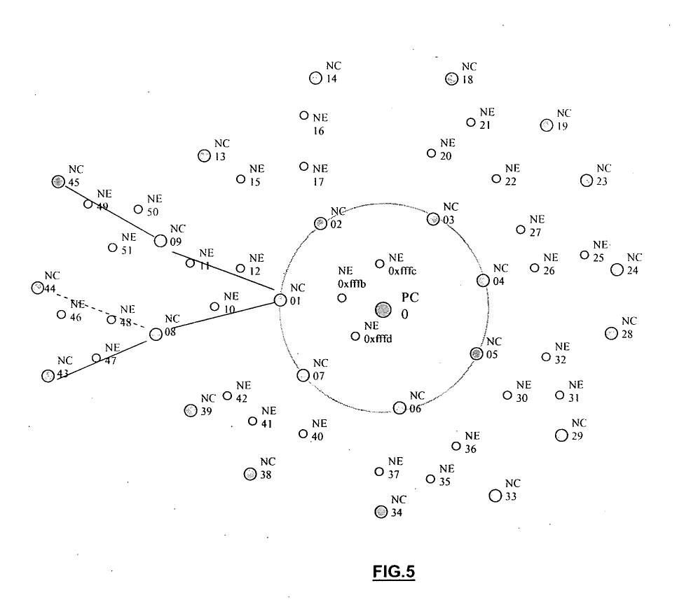

As illustrated in FIG. 3 the RNs required at any depth matches linear function of depth for any value of margin. Hence, the RNs required at any depth n can be written as Rₙ˜k*n. As an example, for m=10%, the Rₙ˜7n. The value 7n means that at any depth n from PC, 7n RNs are sufficient to cover the next level fully. This can also be taken as that any omni-directional network can be divided into k sectors, as an example 7 sectors in this case. Over this, depending upon the requirement or expected node density, the value for maximum number of child end device (Cₘ), other than the child RN, a coordinator can have is configurable. Using this optimization of number of RNs at any depth, there can be plurality of ways in which the address can be allocated to the network elements. As an example we will discuss an addressing scheme where the addresses are assigned on depth and then sector basis as illustrated in FIG. 5. In this scheme the addresses are first reserved for each layer and then for each sector. This scheme shall be considered as an example and not as limitation. There can be plurality of ways in which the address can be allocated using the proposed optimization technique. It shall be easy to manipulate by those ordinarily skilled in the art, the applicability of this invention to match their requirement.

Depending upon the requirement, the maximum number of child end device (Cₘ) a coordinator can have, is be configured.

The total number of nodes at n^{th} depth is:

Nₙ=Num of RNs+Num of EndDevice

[symbol]

N_{b}=kn+k(n−1)Cₘ for n>1 eq 5

Using the above equation, the total number of nodes till n depths (excluding PC and end device associated with PC, since they get address from reserved addresses) is:

$$TNn = \frac{k ( n ) ( n + 1 )}{2} + \frac{{kC}_{m} ( n ) ( n - 1 )}{2} ; \qquad eq 6$$

As per IEEE 802.15.4, the logical address of the personal area network controller (PC) is 0x0000 and there are some reserved values towards 0xffff. In this invention we follow the IEEE 802.15.4 convention and allocate the same 0x0000 to the PC and also keep the reserved address intact. As per proposed algorithm the PC's end devices are allocated address from the values just before the reserved addresses e.g. 0xfffd, 0xfffc.

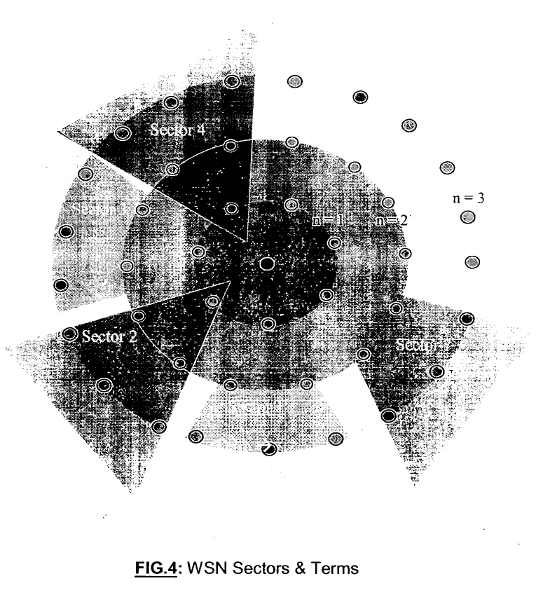

With the assumption of margin being equal to 10% of range (r) we showed in equation 4 that the network can have maximum of 7 child coordinators at level 1. These 7 child coordinator are considered as 7 ‘sectors’ as illustrated in FIG. 4. The position of any node in a particular level and in a particular sector is termed as term.

Having defined the terms, we are now in position to derive the formulas for address allocations. Assume ‘A’ is the address of the current node, ‘d’ is the depth, ‘s’ is the sector, ‘t’ is the term and ‘Cₘ’ is the maximum number of child end device a RN can have. Normally the nodes memorize its depth, sector, term and its parent address, but to calculate it the following formulas are derived:
The value of depth/level is calculated by satisfying the following condition:

(k/2)(d−1)(d+Cₘ(d−2))<A≦(k/2)d(d+1+Cₘ(d−1))

### Sector Calculation:

$$s = ⌈ \frac{A - ( k / 2 ) ( d - 1 ) ( d + {C}_{m} ( d - 2 ) )}{d + {C}_{m} ( d - 1 )} ⌉$$

Term calculation:

$$X = A - ( k / 2 ) ( d - 1 ) ( d + {C}_{m} ( d - 2 ) ) - ( s - 1 ) ( d + {C}_{m} ( d - 1 ) )$$

$$if X < d , then \qquad … ( for coordinator device )$$

$$term = X ;$$

$$else \qquad … ( for end device )$$

$$term = ⌈ \frac{X - d}{{C}_{m}} ⌉ ;$$

### Parent Address (PA):

As we can see that in any sector, the number of RN is equal to its depth. Hence at every increase in depth, one RN is added. The additional RN gets associated to one of the peer parent RN based on configurable network policy. As an example we are associating the additional node to the coordinator which has lower valued logical address because of its little higher chance of existence. Having discussed this, we will now derive the formula to calculate the logical address of the parent node:

Parent depth (pd) is equal to its depth−1; i.e. pd=d−1;
Parent sector (ps) is same as its sector; i.e. ps=s;
As illustrated in FIG. 5 the address is allocated to the RNs first then the EDs in any sector.
The parent term (pt) is calculated as:
If the current node term t=1 then the parent term (pt) is equal to 1 else it is equal to t−1 i.e.
if t==1, then
   pt=1;
else
   pt=t−1;
      Once the parent depth, sector and term have been calculated, its address is calculated as:

PA=(k/2)(pd−1)(pd+Cₘ(pd−2))+(ps−1)(pd+Cₘ(pd−1))+pt;

Similar to parent address calculation, to calculate its child address the child depth, term and sector are calculated:
Child depth (cd)=current depth+1;
Child sector (cs)=current sector; and
The Child term for the reserved address is calculated as:
If the current term=1, then
   Child term (ct)=1;
Else
   Child term (ct)=current term+1;

### Child RN Reserved Address (CRRA):

CRRA=(k/2)*(cd−1)*(cd+Cₘ*(cd−2))+(cs−1)*(cd+Cₘ*(cd−1))+ct

As discussed earlier the RN at term equal to 1 gets the opportunity to create the additional child RN. We will use the term ‘child shared address’ for the addition RN. Hence the Child RN Shared Address (CRSA) is:

CRSA=CRRA+1

As discussed the CRSA is applicable for term 1 node only.
Now we will calculate the end device node address range:
If child term is equal to 1, then

Child end device start address=CRRA+cd;

Child end device end address=CRRA+cd+Cₘ−1;

else

Child end device start address=CRRA+cd+1;

Child end device end address=CRRA+cd+Cₘ;

The above formulas are exemplary based on the addressing scheme chosen that first allocate address to the RNs then to ED at each sector. As discussed there can be plurality of ways in which the addressing can be done even using the proposed optimization technique. However, this invention includes both the optimization as well as addressing techniques.

The above proposed algorithm utilizes the address most optimally, which can sometimes leave some uncovered space based on the distribution of nodes. As an extension to the above proposed algorithm it can be made more robust than using the address most optimally; with robustness it is meant here that it will improve the chance of covering the area fully. Depending on the network dimension and criticality of coverage user can opt for different level of optimization.

The following illustration discusses an exemplary generic and adaptive addressing scheme, which can be easily configured to adjust the address allocation optimization and robustness towards coverage. This illustration shall be taken as an example and not by limitation; the illustration below can be easily manipulated by those ordinarily skilled in the art the applicability of the invention to match their requirement.

One way of improving the robustness of the network is by improving the chance of full function device getting associated with the network as RN. There can be plurality of ways by which the chance of full function device association as RN can be increased, one way of which can be by allowing the network to repeat the address allocation scheme after every ‘p’ depth, i.e. after every p depth each RN will again be able to associate configurable number of child RNs and after that again as previously it will add one RN in every layer per sector till next ‘p’ depth. Other way to improve the robustness of the network is by allowing the node to associate as child RN even if it is not at preferable distance. Yet another method to improve the chance of all nodes getting associated to the network is that in case if the newly associated RN doesn'table to find its proper child RN, it is getting disassociated as child RN and giving the opportunity to other neighboring full function device to associate as its child RN. This disassociation and association will improve the coverage of network.

For the network repetition case when the router node is configured to have 2 child router nodes after every p layers, the number of RNs in any sector will increase like:
1, 2, 3 . . . p, 2p, 2p+1, 2p+2 . . . 2p+p, 6p, 6p+1, 6p+2 . . .
In equation form, for any depth d, the above series is written as:

$${R}_{d} = 2 p [ {2}^{⌊ \frac{d}{p + 1} ⌋} - 1 ] + mod ( d , p + 1 )$$

And the summation of RNs of any sector till depth d is equal to:

$${S}_{d} = ⌊ \frac{d}{p + 1} ⌋ ( \frac{p ( p + 1 )}{2} ) + \frac{mod ( d , p + 1 ) ( mod ( d , p + 1 ) + 1 )}{2} + 2 p ( {2}^{⌊ \frac{d}{p + 1} ⌋} - 1 ) ( mod ( d , p + 1 ) + 1 ) + 2 p ( p + 1 ) [ {2}^{⌊ \frac{d - ( p + 1 )}{p + 1} ⌋ + 1} - 2 - ⌊ \frac{d - ( p + 1 )}{p + 1} ⌋ ]$$

Using the above equations formulas are derived to calculate the child address of any RN. Similar to above case we have configurable parameter for maximum number of child end device (Cₘ) any RN can have. Also as discussed earlier that user can opt for any number of sectors (k) based on their requirement, though 7 sectors are optimum for 10% margin. In this example we will take generic value k for the number of sectors.
Address of RN having depth (d), sector (s) and term (t) is calculated by:

Address=k*[(Cₘ+1)*S_{d-2}+R_{d-1}]+(s−1)*(R_{d}+Cₘ*R_{d-1})+t

Address of end device of any RN, whose depth is d, sector is s and term is t:
End device starting address:

CEDA=k*[(Cₘ+1)*S_{cd-2}+R_{cd-i}]+(cs−1)*(R_{cd}+Cₘ*R_{cd-1})+R_{cd}+(t−1)*Cₘ+1

where cd is child depth (cd=d+1;), cs is child sector (cs=s) and ct is child term;
If either t is equal to 1 or mod (d+1, r+1) is equal to 0, then the current RN can have 2 child RNs, else child term (ct) is equal to current term (t) plus 1. And the child RN address will be:

CCA=k*[(Cₘ+1)*S_{cd-2}+R_{cd-1}]+(cs−1)*(R_{cd}+Cₘ*R_{cd-1})+ct

The following formulas calculate the depth, sector and term from its address A:
Depth: the following condition should satisfy for the depth d:

k*(Cₘ+1)*S_{d-2}+R_{d-1})<A≦k*((Cₘ+1)*S_{d-1}+R_{d})

### Sector:

$$s = ⌈ \frac{A - k * ( ( {C}_{m} + 1 ) * {S}_{d - 2} + {R}_{d - 1} )}{{R}_{d} + {C}_{m} * {R}_{d - 1}} ⌉$$

### Term:

$$X = A - k * [ ( {C}_{m} + 1 ) * {S}_{d - 2} + {R}_{d - 1} ] + ( s - 1 ) * ( {R}_{d} + {C}_{m} * {R}_{d - 1} )$$

$$if X < {R}_{d} , then$$

$$term = X ;$$

$$else$$

$$term = ⌈ \frac{X - {R}_{d}}{{C}_{m}} ⌉ ;$$

The above mentioned algorithms still have some limitations. As the network can grow randomly, the requirement can be totally random at different nodes, which might be difficult to serve based on the above mentioned algorithms because it offers limited number of addresses for the child nodes. A new algorithm has been invented and discussed, which allocates address based on the local requirement. This algorithm is designed to cater the logical address most prudently where the network nodes are placed strategically i.e. the network installer has some idea of how the network will grow. This scheme takes the advantage of such knowledge and helps in allocating the address in efficient manner.

As per this algorithm each router node (RN) is allocated a logical address for it and also a range of logical addresses for its child nodes based on its configurable parameter. The configurable parameter contains the value of number of nodes the network tree will grow beyond that node, i.e. the number of nodes the network will have in that branch after that current node. In situations where the installer has idea of how the network will grow beyond any RN or coordinator capable node, the installer pre-configures the configurable parameter with the value that is the maximum possible number of nodes beyond that node. In the situation where the installer is not sure about the network growth, he configures the parameter accordingly to specify the same. As per this invention the associated node or as part of association procedure the associating node specifies the router node about its requirement of logical addresses; the router node distributes its available addresses based on the all the requests received. The nodes which have specified the exact requirement of the logical address, are allocated that many addresses provided the router node has sufficient addresses available, if sufficient addresses are not available in that case router node initiates address reallocation mechanism (ARM). First the router node requests its parent node for reallocation of address, in case if the parent node does not have address available it, the router node initiates the same procedure with its parent node. Hence recursive ARM gets triggered, this recursive process continues till either PC or configured depth. Based on network configuration, the router node can also initiate ARM with its neighboring node. In case of successful ARM, the router node distributes the logical address based on node's requirement; otherwise the router node distributes the available logical address proportionately. The nodes, which have not specified the exact requirement, receive the logical address based on some configurable parameter of the network. As part of association process the associated node, propagates all the network configurable parameters to its newly joined nodes. As per this algorithm all the coordinator capable devices i.e. PC and RN shares the logical address range information with its neighboring nodes which guides in data routing. The information on how the PC has distributed address to its immediate child nodes and information of configurable hops of neighbor's address range guides the data propagation in power efficient manner.

Yet another possible way to increase the logical address availability to the PC or RN for its child nodes is by increasing the size of logical address. This method can be accompanied with any of the above algorithms to provide more opportunity for the coordinator nodes to allow further association it.

1. A method for allocating logical address optimally to a device at the time of network association with a wireless communication network system, comprising the steps of:
calculating the optimum number of router nodes required at any depth ‘n’ by personal area network controller (PC) based on the configurable parameter ‘margin’, ‘network directionality’ and ‘directionality factor’ of the network to cover the area fully;
developing a logical address allocation algorithm based on the value of said optimum number of router nodes required at any depth (n) and configurable parameters which includes number of end device (Cₘ) a router node can have as its child, the number of depth after which again each router node have the opportunity to have configurable number of router nodes as its child and network policy for allocating additional child router node address among the peer nodes;
calculating the number of router nodes and end device nodes said router node can have as its child, based on said address allocation algorithm;
calculating the area, said router node needs to cover, based on neighboring nodes location and its capability information;
receiving beacon frame from all its neighboring router nodes and building neighbor table by unassociated node, wherein neighbor table contains all the information transmitted in beacon frame and required for association procedure along with its approximate distance from said unassociated node;
transmitting an association request by said unassociated nodes containing said neighbor table information to one of said neighboring router node based on its preference which includes signal strength of received beacon, personal area network identity and depth of said router node;
accumulating all the association requests and then processing it by said router node to calculate its approximate location based on the said neighbor table information transmitted as part of association request by said unassociated nodes and said router node's own neighbor table information;
finding out number of full function device unassociated nodes said router node can have as its child router nodes within the margin which are relatively equidistant from the neighboring router nodes i.e. it forms the network relatively homogeneous than other possible nodes; and
associating said full function device unassociated nodes which are relatively equidistant from neighboring router nodes as its child router nodes and associating other nodes as its child end device nodes,
whereby the network uses the address in optimum manner and enables the network to grow longer, also the data routing is faster since the address is allocated based on the formula, the shortest path can be calculated based on the address allocation formula.

2. The method as claimed in claim 1, wherein calculating said optimum number of router nodes at any depth ‘n’ to cover the area fully comprises the steps of:
calculating the area covered by said router node at its child node's depth based on configurable parameters; and
dividing the total area at child node's depth calculated based on “network directionality” and directionality factor” of said network by said area covered by said router node,
whereby optimum number of router nodes required at any depth to cover the desired area fully is obtained.

3. The method as claimed in claim 1, wherein on every unsuccessful event of said finding out full function device unassociated nodes within the margin, said router node checks margin range closer by margin to find out full function device unassociated node.

4. The method as claimed in claim 2, wherein said area which is covered by said router node at its child node's depth is calculated based on factors comprising:
depth of said router node from the personal area network controller; and
margin, which is a configurable percent of said router node's transmission range in which router node prefers its child router node.

5. The method as claimed in claim 2, wherein said total area to cover at child node's depth is calculated based on factors comprising:
network directionality, which is a configurable parameter to indicate the directionality of network growth, which includes for uni-directional network (=1), bi-directional network (=2) and so on, for omni-directional network said network directionality is equal to directionality factor of the network; and
directionality factor, which is a configurable parameter which allows user to divide the omni-directional network into that many number of factors.

6. The method as claimed in claim 2, wherein said optimum number of router nodes required covering the desired area fully, is directly proportional to said depth of the router node and network directionality.

7. The method as claimed in claim 2, wherein said optimum number of router nodes required covering the desired area fully is inversely proportional to said margin and directionality factor of the network.

8. The method as claimed in claim 1, wherein developing logical address allocation algorithm is comprising the steps of:
ascertaining depth, sector and term of said associating node (i.e. the unassociated node), which is trying to associate with the network;
allocating logical address to said associating node based on the depth of said associating node;
allocating logical address to said associating node based on the sector of said associating node;
allocating logical address to said associating node based on the term of said associating node;
allocating logical address to said associating node based on said number of end devices a router node can have as its child;
allocating logical address to said associating node based on the configurable parameter network periodicity i.e. the depth after which each router node gets the opportunity to have configurable number of router nodes as its child; and
allocating logical address to said associating node based on the configurable network policy according to which the additional child router node address is allocated among the peer nodes:
whereby said associating node logical address is equal to address consumed till previous depth plus address consumed till previous sector at current depth plus address consumed till previous term at current depth plus said term of associating node plus end device factor, where end device factor is null for router nodes and for end device it is equal to the number of associated end devices.

9. The method as claimed in claim 1, wherein said depth is the number of hops away from the personal area network controller (PC) of the wireless communication network.

10. The method as claimed in claim 8, wherein said sector signifies the branch detail of the network which originates from the router node directly associated with said personal area network controller (PC).

11. The method as claimed in claim 8, wherein said term signifies the position of said node with respect to its peer nodes associated with the same parent node.

12. The method as claimed in claim 8, wherein depth of said associating node is equal to the router node depth plus 1, where the router node is the node which is allowing said associating node to associate with it.

13. The method as claimed in claim 8, wherein sector of said associating node is equal to sector of the router node.

14. The method as claimed in claim 8, wherein term of said associating node depends on term of the router node and network policy for allocating term value for additional addresses of child nodes.

15. A method for allocating logical address optimally to a device at the time of network association with a wireless communication network system, comprising the steps of:
configuring the full function device with the prior information of network growth beyond it for reserving the logical addresses, for case where user has no prior information of network growth beyond said full function device, the full function device is configured accordingly to indicate that it has no prior information about the network growth;
receiving beacon frame from all its neighboring router nodes and building neighbor table by unassociated node, wherein neighbor table contains all the information transmitted in beacon frame and required for association procedure along with its approximate distance from said unassociated node;
transmitting the association request by unassociated nodes as part of its association procedure, association request containing the information about its said logical address requirement, which is said configured value for full function device and null for reduced function device;
accumulating the association request for configurable period (T_{ASSOC}_{_{—}}_{RES}) by said router nodes and then adding the address requirements of each said association request to get the total address requirement;
checking the available logical addresses for distribution by said router nodes, whether all the association requests requirement can be fulfilled;
allocating the requested number of logical addresses to the associating nodes which have specified their requirements, provided said router node has sufficient availability of logical addresses;
alternatively, in case said router node does not have sufficient availability of logical addresses to meet all the requests, taking address reallocation mechanism (ARM), which on success said router node allocating the logical addresses as per request in said association requests, otherwise allocating the available logical addresses proportionally based on requested values in said association requests and availability of logical addresses with said router node;
allocating the logical addresses to said unassociated nodes based on network configurable parameters, node's depth and availability of logical addresses where said unassociated nodes have not specified its logical address requirement in said association request; and
propagating the network configurable parameters by said router node to all associating nodes,
whereby the logical address is allocated based on the associating node's requirement and network configurable parameters which prudently uses the available logical address and thus improves the chance of all the unassociated node getting associated with the network.

16. The method for allocating logical addresses as claimed in claim 15, wherein said address reallocation mechanism (ARM) comprises the steps of:
said router node requesting its parent node for additional logical address requirement;
in case of availability of requested number of addresses, said router node's parent node allocating the required logical addresses, otherwise taking said address reallocation mechanism (ARM) with its parent node, this recursive step can span up to preconfigured depth or by default up to personal area network controller (PC); and
said parent node responding to said router node about the newly allocated addresses,
whereby logical addresses are reallocated.

17. The method for allocating logical addresses as claimed in claim 15, wherein said address reallocation mechanism (ARM) comprises the steps of:
said router node requesting its neighboring node for additional logical address requirement;
in case of availability of requested number of addresses, said router node's neighboring node allocating the required logical addresses, otherwise taking said address reallocation mechanism (ARM) with its neighboring or parent node based on configuration, this recursive step can span up to preconfigured depth or by default up to personal area network controller (PC);
said neighboring node responding to said router node about the allocated new addresses;
said neighboring node informing its parent node about said distribution of its logical address; and
said router node informing its parent node about said reallocation of logical address,
whereby logical addresses are reallocated.

18. A method for routing data packet through shortest path in a wireless communication network system, where the address allocation algorithm is based on claim 1, comprising the steps of:
data packet generator node specifying the depth, sector, term and destination address information in data packet;
on reception of said data packet, current node which received said data packet ascertaining the depth, sector and term information of the destination location of said data packet, in case the depth, sector and term information is not readily available, said current node calculating it based on network configuration;
based on destination node's depth, destination node's sector, destination node's term, said current node's depth, current node's sector, current node's term, network directionality and directionality factor, said current node calculating the approximate direction of the destination node;
said current node finding out the next hop node nearest to the destination node based on information in its neighbor table about the neighboring node and said approximate direction of the destination node; and
said current node applying said next hop node as destination address in medium access control (MAC) header and transmitting said data packet:
whereby any data packet reaches its destination in minimum hops.

19. The method as claimed in claim 18, wherein said depth (d) of said destination node in said wireless communication network system is ascertained by satisfying the inequality given below:
k*((Cₘ+1)*S_{d-2}+R_{d-1})<A≦k*((Cₘ+1)*S_{d-1}+R_{d})
where A is said destination node address, d is said depth of destination node, k is number of sectors in said network, Cₘ is maximum number of child end device any router node or personal area network controller can have as its child, p is said network periodicity after which router node can have configured number of child router nodes as its child, wherein nodes are configured to have two child router nodes after p layers, R_{d} stands for number of router nodes at depth d, and S_{d} stands for number of router node till depth d in a sector,
$${R}_{d} = 2 p [ {2}^{⌊ \frac{d}{p + 1} ⌋} - 1 ] + mod ( d , p + 1 )$$
$${S}_{d} = ⌊ \frac{d}{p + 1} ⌋ ( \frac{p ( p + 1 )}{2} ) + \frac{mod ( d , p + 1 ) ( mod ( d , p + 1 ) + 1 )}{2} + 2 p ( {2}^{⌊ \frac{d}{p + 1} ⌋} - 1 ) ( mod ( d , p + 1 ) + 1 ) + 2 p ( p + 1 ) [ {2}^{⌊ \frac{d - ( p + 1 )}{p + 1} ⌋ + 1} - 2 - ⌊ \frac{d - ( p + 1 )}{p + 1} ⌋ ] .$$

20. The method as claimed in claim 19, wherein number of sectors (k) in said wireless communication network is ascertained using formula given below:
$$k = ⌈ ( \frac{nwkDirectionality}{directionalityFactor} ) * \frac{π}{{Cos}^{- 1} [ 1 - \frac{m ( 2 + m )}{2 n ( n + 1 )} ]} ⌉$$
by applying n=1 and
where k is said number of sectors in the wireless communication network, margin is the preferable range in which any router node would prefer to have its child router node, m percent of transceiver range is margin, nwkDirectionality is said network directionality, and directionality Factor is said directionality factor.

21. The method as claimed in claim 18, wherein said sector of said destination node in said wireless communication network system as is ascertained using formula given below:
$$s = ⌈ \frac{A - k * ( ( {C}_{m} + 1 ) * {S}_{d - 2} + {R}_{d - 1} )}{{R}_{d} + {C}_{m} * {R}_{d - 1}} ⌉$$
where A is said destination node's address, k is said number of sectors in the wireless communication network, Cₘ is maximum number of child end device any router node or personal area network controller can have as its child, R_{d} stands for said number of router nodes at depth d, and S_{d} stands for said number of router node till depth d.

22. The method as claimed in claim 18, wherein said term of said destination node in said wireless communication network system is ascertained using formula given below:
$$X = A - k * [ ( {C}_{m} + 1 ) * {S}_{d - 2} + {R}_{d - 1} ] + ( s - 1 ) * ( {R}_{d} + {C}_{m} * {R}_{d - 1} )$$
$$if X < {R}_{d} , then$$
$$term = X ;$$
$$else$$
$$term = ⌈ \frac{X - {R}_{d}}{{C}_{m}} ⌉ ;$$
where A is said destination node's address, k is said number of sectors in the wireless communication network, s is sector of said destination node, Cₘ is maximum number of child end device any router node or personal area network controller can have as its child, R_{d} stands for said number of router nodes at depth d, and S_{d} stands for said number of router node till depth d.

23. The method as claimed in claim 18, wherein logical address of router node having depth d, sector s and term t are ascertained using formula below:
Address=k*[(Cₘ+1)*S_{d-2}+R_{d-1}]+(s−1)*(R_{d}+Cₘ*R_{d-1})+t
where k is said number of sectors in the wireless communication network, s is sector of said destination node, Cₘ is maximum number of child end device any router node or personal area network controller can have as its child, R_{d} stands for said number of router nodes at depth d, and S_{d} stands for said number of router node till depth d.

24. The method as claimed in claim 18, wherein starting of logical address of end device of any router node, whose depth is d, sector is s and term is t is ascertained using formula below:
CEDA=k*[(Cₘ+1)*S_{cd-2}+R_{cd-1}]+(cs−1)*(R_{cd}+Cₘ*R_{cd-1})+R_{cd-1})+R_{cd}+(t−1)*Cₘ+1
where cd is child depth i.e. cd=d+1, cs is child sector i.e. cs=s, ct is child term, k is said number of sectors in the wireless communication network, s is sector of said destination node, Cₘ is maximum number of child end device any router node or personal area network controller can have as its child, R_{d} stands for said number of router nodes at depth d, and S_{d} stands for said number of router node till depth d.

25. A method for routing data packet through shortest path in a wireless communication network system, where the address allocation algorithm is based on claim 15, comprising the steps of:
on reception of data packet, node which received said data packet finding out the destination address from the data packet;
said node finding out the next hop node nearest to the destination node based on information in its neighbor table about the neighboring node logical address range and destination address;
in case said node does not find any neighboring node having destination address in its logical address range, said node applying next hop node as its parent node; and
said node applying said next hop node as destination address in medium access control (MAC) header and transmitting said data packet,
whereby any data packet will reach its destination in minimum hops.

26. A system for networking a wireless communication device having networking capabilities with a wireless communication network as claimed in claim 1 comprising:
a full function device personal area network controller (PC);
a reduced function device end device (ED);
means for calculating the optimum number of router nodes required at any depth ‘n’ by personal area network controller (PC) based on the configurable parameter ‘margin’, ‘network directionality’ and ‘directionality factor’ of the network to cover the area fully;
means for developing an logical address allocation algorithm based on the value of said optimum number of router nodes required at any depth (n) and configurable parameters which includes number of end device (Cₘ) a router node can have as its child, the number of depth after which again each router node have the opportunity to have configurable number of router nodes as its child and network policy for allocating additional child router node address among the peer nodes;
means for calculating the number of router nodes and end device nodes said router node can have as its child, based on said address allocation algorithm;
means for calculating the area, said router node needs to cover, based on neighboring nodes location and its capability information;
means for receiving beacon frame from all its neighboring router nodes and building neighbor table by unassociated node, wherein neighbor table contains all the information transmitted in beacon frame and required for association procedure along with its approximate distance from said unassociated node using received signal strength;
means for transmitting an association request by unassociated nodes containing said neighbor table information to one of said neighboring router node based on its preference which includes signal strength of received beacon, personal area network identity and depth of said router node;
means for accumulating all the association requests and then processing it by router node to calculate its approximate location based on the said neighbor table information transmitted as part of association request by said unassociated nodes and said router node's own neighbor table information;
means for finding out number of full function device unassociated nodes said router node can have as its child router nodes within the margin which are relatively equidistant from the neighboring router nodes i.e. it forms the network relatively homogeneous than other possible nodes; and
means for associating said full function device unassociated nodes which are relatively equidistant from neighboring router nodes as its child router nodes and associating other nodes as its child end device nodes,
whereby the network uses the address in optimum manner and enables the network to grow longer, also the data routing is faster since the address is allocated based on the formula, the shortest path can be calculated based on the address allocation formula.

27. The system as claimed in claim 26 comprising a full function device personal area network controller, a full function device router node and a reduced function device end device.

28. The system as claimed in claim 26, wherein said full function device is a wireless networking device capable of networking with reduced function device or other full function device and it is capable to operate in three modes serving as personal area network controller (PC), a router node (RN) or as an end device (ED).

29. The system as claimed in claim 26, wherein said reduced function device is a wireless networking device capable of networking with only full function device and it can serve as end device (ED) in any network.
